(19) United States
(12) Patent Application Publication
(10) Pub. No.: US 2015/0290640 A1
(43) Pub. Date: Oct. 15, 2015

(54) VESSEL

(71) Applicant: RPC FORMATEC GMBH, Mellrichstadt (DE)

(72) Inventor: Sabine Goettke, Lohne (DE)

(73) Assignee: RPC Formatec GmbH, Mellrichstadt (DE)

(21) Appl. No.: 14/437,558

(22) PCT Filed: Oct. 15, 2013
(86) PCT No.: PCT/EP2013/071457

§ 371 Date: Apr. 22, 2015

(30) Foreign Application Priority Data
Oct. 23, 2012 (DE) 10 2012 110 111.6

(51) Int. Cl. B01L 3/00

(52) U.S. Cl. CPC B01L 3/50825; B01L 2300/042; B01L 2200/0689

(57) ABSTRACT

A vessel, in particular for receiving small quantities of liquid, for example for receiving analysis samples, has a vessel body which has a small diameter relative to a vessel length. The vessel body has a longitudinal axis and an opening which can be closed by a screw cap. This vessel is advantageously easy to handle with respect to closing the vessel. The screw cap can be secured by plugging the screw cap in the direction of the longitudinal axis in order to close the opening using an adapter part to which the screw cap is screw-fastened; afterwards, however, the opening can only be released by unscrewing the screw cap.

The invention relates to a vessel, particularly for receiving small quantities of liquid, for receiving analysis samples, for example, preferably comprising a vessel body which has a smaller diameter relative to a vessel length, wherein the vessel body has a longitudinal axis and an opening that is closable with a screw cap.

Such vessels are already known in several variants. In particular, the invention relates to a sample vial such as is used in the medical field to transport and store body fluids, for example blood. The vessel is the type of vessel that is referred to more particularly as a cuvette.

In vessels of such kind, see for example EP 1 981 637 A1, the opening may be closed and opened by screwing and unscrewing the screw cap. The objective on the one hand is to ensure secure handling, in particular a secure closure. On the other hand, however, manipulating the screw cap is not always consistent with the urgency with which action must be taken, or the fact that, in some circumstances closure must be effected with one hand.

On the basis of the cited prior art, the invention is concerned with the task of suggesting vessel particularly for receiving samples for analysis that can be handled conveniently with respect to the closure thereof.

According to a first inventive idea, one possible solution to the problem is given in the form of a vessel in which, in order to close the opening, the screw cap may be secured by plugging with an adapter part, to which it is screw-fastened, in the direction of the longitudinal axis, but the opening may then be unblocked simply by unscrewing the screw cap.

According to this approach, the principle of the proven screw cap is retained, but the closure of the vessel is simplified significantly. The screw cap may be placed over the opening to block it with a simple plugging movement. An axial movement in the direction of the longitudinal axis of the vessel is all that is required. At the same time, the ability to unblock the opening by unscrewing is retained.

Further features of the invention are described and illustrated in the following, and in the description of the figures and the drawing, often in the preferred association thereof with the concept explained in the preceding, although they may also be significant in conjunction with only one or several individual features, described or represented graphically here, or independently, or in another overall concept.

In order to enable the screw cap to be unscrewed, the adapter part is preferably connected to the vessel in fixed manner, particularly in a rotationally fixed manner. This may be achieved with an interference fit, for example. To this extent, it is preferred that the adapter part is secured against rotation with respect to the vessel body in positive locking manner.

If such is not achieved for example by a tight fit, it is further preferred that special measures be implemented to retain the adapter part on the vessel body so that it cannot be pulled off. Such means for preventing detachment may be provided for example with a detent mechanism.

It is further preferred that the mounting of the adapter part is provided on an outer surface of the opening, that is to say on the outside of an opening area of the vessel body that extends into the opening. Accordingly, it is not necessary for the adapter part to engage in the opening or even to cooperate with an inner surface of the vessel, in particular even in the opening area, although generally this is still possible as well. However, it is further preferred that the adapter part is only retainable on the outside of the opening area of the vessel body.

For the preferred securing against rotation by positive locking means, it is preferably further provided that ribs are provided, extending in the longitudinal direction along said opening area of the vessel. Said ribs may further preferably be distributed unevenly about the circumference. Groups of ribs may also be provided, wherein the ribs of one group are conformed relatively close to each other, but the groups are arranged at greater distances from one another. The groups may be evenly distributed about the circumference. However, it is also possible to provide only two groups, preferably opposite one another, and one or two additional, single ribs. In principle, sufficient rotational rigidity with respect to an assigned inner surface of the adapter part may already be assured with the aid of such ribs, when said inner surface is of smooth construction, since in the attached state the ribs cause a certain deformation in the contact areas thereof with the inner surface of the adapter part due to a high concentration of tension. However, it is further preferred that grooves corresponding to the ribs are conformed on the inner side of the adapter part.

In general, it is also possible for locations of the ribs and the grooves to be reversed, that is to say that the grooves are conformed in the opening area of the vessel and the ribs are formed on the adapter part.

In addition, in order to effectively prevent detachment thereof, it is preferred that a protruding detent projection is conformed transversely to the direction of the longitudinal axis of the vessel on the outside of the opening area. This detent projection may serve to cooperate with a counter-locking mechanism, which may be conformed on the adapter part.

To this extent, it is further preferable that in the assembled state the detent projection engagingly clasps an outwardly biased shoulder conformed on the adapter part over a substantial part or even the entire circumference of the adapter part.

Said detent projection is preferably conformed on the opening side of the positive locking formations on the opening area of the vessel, that is to say in particular on the opening side of the ribs. Further preferably, the detent projection may more conformed in the direction of the longitudinal axis of the vessel at a distance from an opening side end of the ribs.

The adapter part itself may preferably be in the shape of a tube section. Somewhat in the manner of a sleeve. Thus, ring substantially in the form of a cylinder section is created, which is however structured on the outside and inside with thread formations or positive locking formations.

In addition, a flange protruding radially outwardly relative to the longitudinal axis of the vessel may be conformed on the front of the adapter part and in the direction of attachment thereof. The screw cap, for example, may be seated on this flange with a corresponding end face of the outer circumferential area, the thread being conformed on the inside thereof.

A radially outwardly open recess may be conformed on the inside of the adapter part, that is to say relative to a matching transverse plane or matching transverse area and assigned to the outwardly projecting flange. In the attached state, said recess may cooperate with a further flange section, which may be conformed below the detent formations on the opening area of the vessel.

The screw cap itself may have a closed cover and a surrounding circumferential casing area, as described previously, in which circumferential casing area one or more threads are conformed to cooperate with an outer thread on the adapter part. Further, the screw cap may comprise a cylindrical section radially inwardly with respect to the outer cladding area, which section is conformed to project from the cover toward the opening plane of the screw cap. This cylindrical section may be constructed to have an axial length relative to the longitudinal axis of the vessel in the screwed state such that when mounted on the vessel it protrudes into the interior of the vessel. A seal may be arranged in the cover in the annular space between the inner cylindrical section and the outer casing area.

In the following, the invention will be explained in greater detail with reference to the accompanying drawing, which however illustrates only one exemplary embodiment. In the drawings:

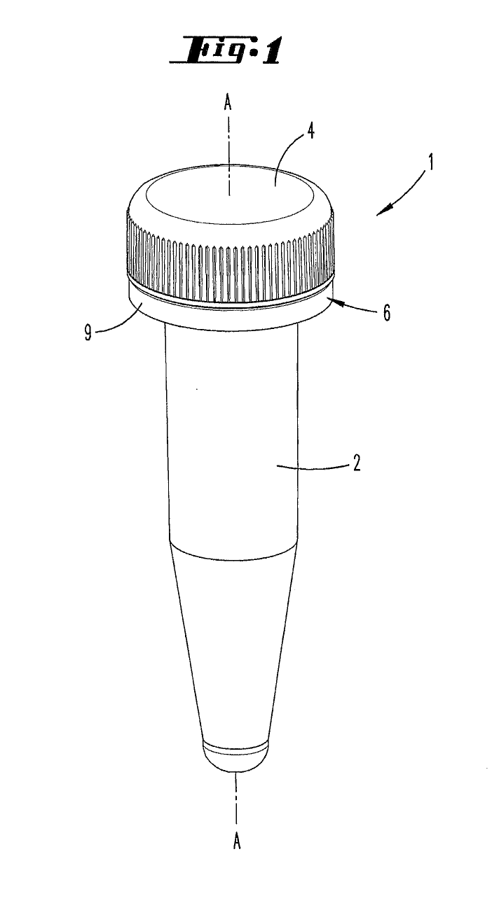

FIG. 1: is a perspective representation of the closed vessel in the form of a receptacle for samples;

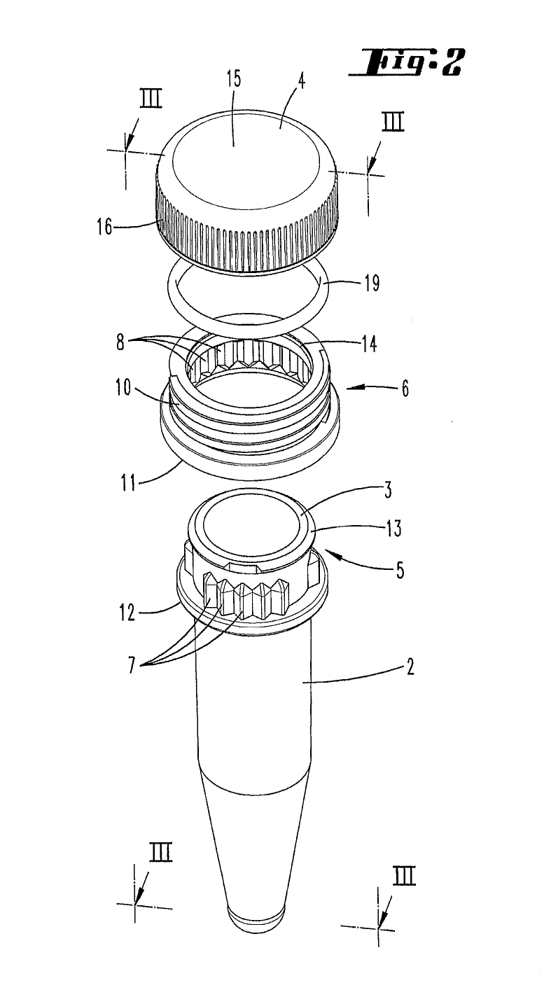

FIG. 2: is a perspective exploded cross-sectional representation of the sample vessel of FIG. 1;

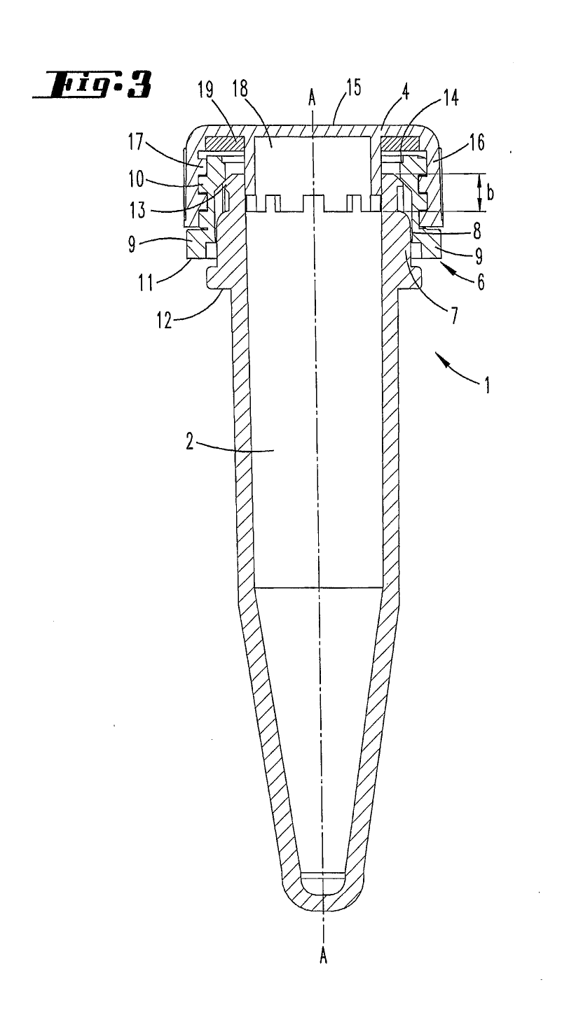

FIG. 3: is a cross-sectional representation of the vessel with screw cap plugged but not fastened;

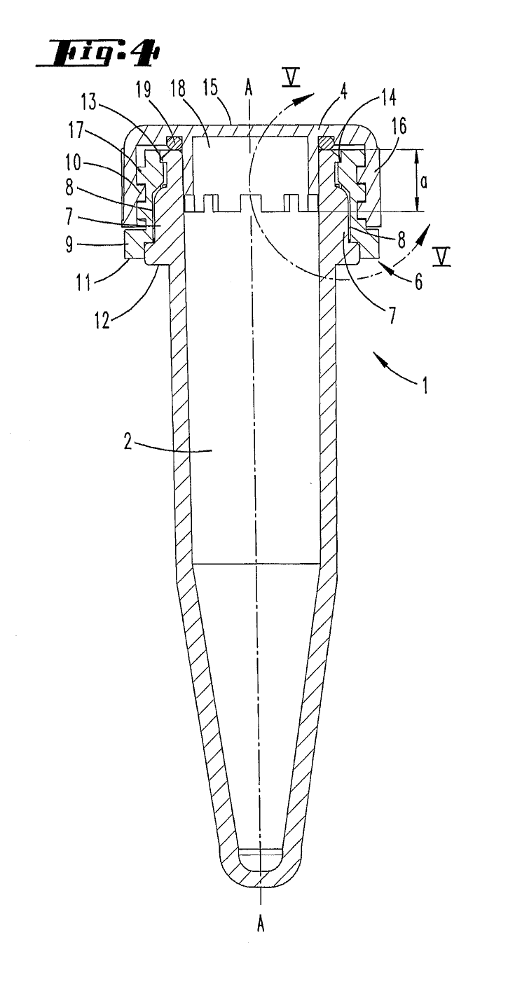

FIG. 4: is a representation according to FIG. 3 with the screw cap fastened; and

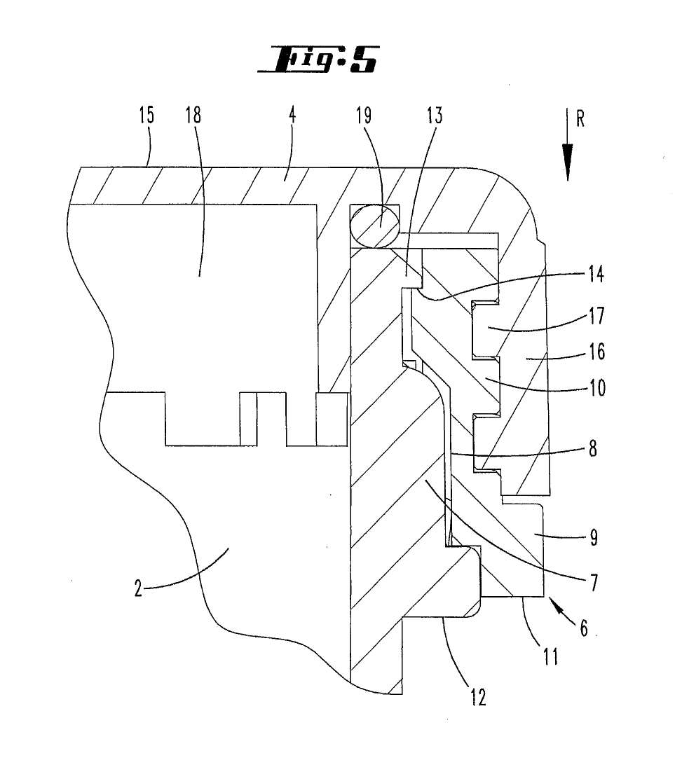

FIG. 5: shows an enlarged cross sectional view of area V-V of FIG. 4.

A vessel 1 in the form of a sample receptacle having a lower vessel body 2 with a closed bottom is represented and described. At the top, as shown in FIG. 2, vessel 1 has an opening 3, which is closed by a screw cap 4.

As is shown in detail in FIG. 2 for example, vessel body further has a longitudinal axis A that is initially slightly conically shaped in a body area immediately below an opening area 5, and preferably then tapers conically more markedly towards the bottom thereof.

Screw cap 4 cooperates with an adapter part 6.

In a state at the start of handling, separate adapter part 6 is screwed into cap 4, see also the state shown in FIG. 3, for example, after it has been mounted on vessel 1.

This combination of screw cap 4 and adapter part 6 can then be connected to vessel body 2 simply by plugging it into the body in the direction of longitudinal axis A.

In order to enable unscrewing of screw cap 4 to unblock the opening subsequently while leaving adapter part 6 attached to vessel body 2, adapter part 6 is attached in rotationally fixed manner to container body 2.

Adapter part 6 is preferably also fastened to vessel body 2 by additional means to prevent it from being pulled off.

The rotational lock may be assured positive locking elements conformed in the vessel body, the opening area 5 thereof, and/or on adapter part 6, preferably on the inner surface thereof.

In detail, the positive locking elements may consist of ribs 7 conformed on opening area 5, and optionally grooves 8 conformed on the inside of adapter part 6 and cooperating with ribs 7. As may be seen in FIG. 2, ribs 7 are preferably arranged in two oppositely positioned groups of five ribs arranged together with practically no separation therebetween, and two further single ribs arranged equidistantly between the two groups and preferably also opposite one another.

Further preferably, adapter part 6 is configured as shown, in the form of a sleeve or tube section. At all events, it preferably has no bottom and/or no top cover. Merely a circumferential casing wall 9.

One or more threads 10 are conformed on the outside of said circumferential casing wall 9 of adapter part 6, and grooves 8 are formed on the inside thereof. In the attached state, grooves 8 are preferably conformed transversely to longitudinal axis A and at least partially overlapping threads 10.

Adapter part 6 further comprises a flange 11 on the front side thereof in connecting direction R, which flange is extended radially outwardly compared with the section of the casing wall 9 located above it. This extension preferably has the form of a step-like protrusion.

Further preferably, in the attached state said flange 11 engages over a vessel flange 12 conformed on the vessel, as shown in FIG. 5.

A preferably continuous circumferential detent protrusion 13 is conformed on the opening side of opening area 5 of vessel body 2 and at a distance from the positive locking formations. As shown in FIG. 5, in the mounted state detent protrusion 13 engages over a corresponding recess 14 on the inner wall of adapter part 6.

Screw cap 4 has a cover 15 that becomes a radially outward cap wall 16. Threads 17 are formed on the inside of cap wall 16, which in the screwed state according to FIG. 3 or FIG. 5, cooperate with the threads 10 of adapter part 6.

A cylindrical section 18 extends from cap cover 15 in a plugging direction R. Cylindrical section 18 is preferably conformed with an axial length such that in the plugged state, as shown in FIG. 5, the side thereof facing the inner wall of opening area 5 overlaps the inner wall of the opening area. An overlap length a is preferably chosen such that at the beginning of a plugging state as shown in FIG. 3, in which ribs 7 and grooves 8 are substantially engaged with each other but adapter part 6 has not locked together with vessel body 2, an overlap already exists with a smaller overlap dimension b. Thus, advantageous guidance is provided for the axial approach of the screw cap 4 combined with adapter part 6 and the vessel body 2.

A seal 19 is inserted on the inside of the closure cap between cylindrical section 18 and cap wall 16. Seal 19 may be designed as a circumferential gasket (FIGS. 4, 5). In this case, it is preferably only effective between cover 15 (inner side) of screw cap 4 and an end face of opening area 5 of the vessel 1. However, it may also be in the form of an annular sealing ring, as shown in FIG. 3. It should be noted here that the screw cap 4 is not fully closed as shown in FIG. 3, and is only shown in the fully closed state in FIG. 4. The seal 19 have been altered here for illustrative purposes only, wherein a design change visible on the cover side of screw cap 4 is also associated therewith.

Seal 19 in the form of an annular sealing ring according to FIG. 3 extends radially such that it extends over both end faces, the end face of both opening area 5 of vessel 1, and the end face of adapter part 6. Given the structure of seal 19 as an annular gasket, the inner surface of cover 15 of screw cap 4 is preferably designed such that the gasket lies flush with the inside of cover 15, as also shown in FIG. 3.

All features disclosed (per se) essential to the invention. The disclosure contents of the associated/accompanying priority documents (transcript of prior application) are herewith also incorporated in full in the disclosure of the application, also for the purpose of including features of said documents in claims of the present application. In the optionally coordinate version thereof, the dependent claims characterize independent inventive refinements of the prior art, in particular with a view to making divisional applications based on these claims.

REFERENCE LIST

| | |
|---|---|
| 1 | Vessel |
| 2 | Vessel body |
| 3 | Opening |
| 4 | Screw cap |
| 5 | Opening area |
| 6 | Adapter part |
| 7 | Ribs |
| 8 | Grooves |
| 9 | Circumferential casing wall |
| 10 | Thread |
| 11 | Flange |
| 12 | Vessel flange |
| 13 | Detent projection |
| 14 | Recess |
| 15 | Cover |
| 16 | Cap wall |
| 17 | Thread |
| 18 | Cylinder section |
| 19 | Seal |
| a | Overlap length |
| A | Longitudinal axis |
| b | Overlap dimension |
| R | Plugging direction |

1-10. (canceled)

11. A vessel, particularly for receiving small quantities of liquid, for receiving analysis samples, for example, preferably comprising a vessel body (2) which has a smaller diameter relative to a vessel length, wherein the vessel body (2) has a longitudinal axis (A) and an opening (3) that is closable with a screw cap (4), wherein in order to close the opening (3) the screw cap (4) can be secured by plugging with an adapter part (6), to which it is screw-fastened, in the direction of the longitudinal axis (A), but the opening (3) can then be unblocked simply by unscrewing the screw cap (4).

12. The vessel according to claim 11, wherein the plugged adapter part (6) is rotationally locked onto the vessel body (2) in positive locking manner.

13. The vessel according to claim 11, wherein the plugged adapter part (6) is fastened to the vessel body (2) in a manner that prevents it being pulled off.

14. The vessel according to claim 11, wherein the adapter part (6) is retainable on the outside of an opening area (5) of the vessel body (2) that extends into the opening (3).

15. The vessel according to claim 11, wherein ribs (7) are conformed along the outside of the opening area (5), extending in the direction of the longitudinal axis (A).

16. The vessel according to claim 15, wherein the ribs (7) are unevenly distributed about the circumference.

17. The vessel according to claim 15, wherein grooves (8) are formed corresponding to the ribs (7) on the inside of the adapter part (6).

18. The vessel according to claim 14, wherein a protruding detent projection (13) is conformed on the outside of the opening area (5) and transversely to the direction of the longitudinal axis (A).

19. The vessel according to claim 18, wherein the detent projection (13) is preferably conformed on the opening side of the ribs (7).

20. The vessel according to claim 18, wherein the detent projection (13) is conformed at a distance from the ribs (7) in the direction of the longitudinal axis (A).

21. The vessel according to claim 11, wherein the adapter part (6) is in the form of a tubular section.

22. The vessel according to claim 11, wherein the screw cap (4) has an internal thread and the adapter part (6) an associated external thread.

23. The vessel according to claim 17, wherein the grooves (8) formed on the inner surface of the adapter part (6) extend in overlapping relationship to one or more of the threads (10) conformed on the outer surface of the adapter part (6).

24. The vessel according to claim 22, wherein the adapter part (6) has an outwardly projecting flange (11) below the external thread in the screwing direction.
